(19) United States
(12) Patent Application Publication
(10) Pub. No.: US 2025/0148642 A1
(43) Pub. Date: May 8, 2025

(54) CALIBRATION OF EYE TRACKING SYSTEM

(71) Applicant: Meta Platforms Technologies, LLC, Menlo Park, CA (US)

(72) Inventor: Wei Wu, Bellevue, WA (US)

(21) Appl. No.: 18/218,422

(22) Filed: Jul. 5, 2023

(51) Int. Cl. G06T 7/80; G06F 3/01

(52) U.S. Cl. CPC G06T 7/80; G06F 3/013

(57) ABSTRACT

A calibration system includes a head mounted device including an eye tracking (ET) system, processing logic coupled to the ET camera, and a calibration apparatus removably coupled to the head mounted device. The ET camera may take an image of a plurality of 3D objects on the calibration apparatus to collect calibration information and use the calibration information to update eye tracking parameters for the ET camera. The calibration apparatus may include a plurality of 3D pillars or cylinders having varying heights and which are located at varying distances from each other.

### TECHNICAL FIELD

This disclosure relates generally to Artificial Reality (AR) and Virtual Reality (VR), and in particular to calibration of AR/VR head mounted devices.

### BACKGROUND INFORMATION

Eye tracking (ET) during an AR/VR session is becoming increasingly important for many applications and features for head mounted devices. Eye tracking technology enables head mounted devices to interact with users based on the users' eye movement or eye orientation. Typically, the factory will calibrate the head mounted device before its release to customers. Once home with the customer or user, however, the product may be impacted by various mechanical or thermal effects. For example, during the lifetime of the products, the head mounted device may be dropped or shaken or exposed to various temperature changes, e.g., seasonal changes such as winter to summer.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a portion of an example head mounted device coupled to a calibration apparatus, in accordance with aspects of the disclosure.

FIG. 2 illustrates an enlarged planar view of an example calibration apparatus, in accordance with aspects of the disclosure.

FIG. 3 illustrates another portion of an example head mounted device including the calibration apparatus, in accordance with aspects of the disclosure.

FIG. 4 is an example flow diagram, in accordance with aspects of the disclosure.

FIG. 5 illustrates a head mounted device coupled to a charging apparatus, in accordance with aspects of the disclosure.

### DETAILED DESCRIPTION

Embodiments of a head mounted device and a calibration apparatus removably coupled to the head mounted device are described herein. In aspects, the calibration apparatus assists in calibrating an eye tracking (ET) camera of the head mounted device. In aspects, the calibration apparatus includes a plurality of 3D objects, e.g., cylinders or pillars having varying heights which are located at varying distances from each other.

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some implementations of the disclosure, the term “near-eye” may be defined as including an element that is configured to be placed within 50 mm of an eye of a user while a near-eye device is being utilized. Therefore, a “near-eye optical element” or a “near-eye system” would include one or more elements configured to be placed within 50 mm of the eye of the user.

In aspects of this disclosure, visible light may be defined as having a wavelength range of approximately 380 nm-700 nm. Non-visible light may be defined as light having wavelengths that are outside the visible light range, such as ultraviolet light and infrared light. Infrared light having a wavelength range of approximately 700 nm-1 mm includes near-infrared light. In aspects of this disclosure, near-infrared light may be defined as having a wavelength range of approximately 700 nm-1.6 μm.

In aspects of this disclosure, the term “transparent” may be defined as having greater than 90% transmission of light. In some aspects, the term “transparent” may be defined as a material having greater than 90% transmission of visible light.

As noted above, eye tracking (ET) is becoming increasingly essential for the function of many applications and features of head mounted devices. ET performance is highly sensitive to proper calibration based on the positions of camera modules and light sources. During regular operation or transport, however, the head mounted device may be subject to movement and environmental forces. Accordingly, the head mounted device may need to be re-calibrated at intervals to achieve the same level of performance as right after the factory calibration. Unfortunately, it is not practical to send it back to the factory for recalibration.

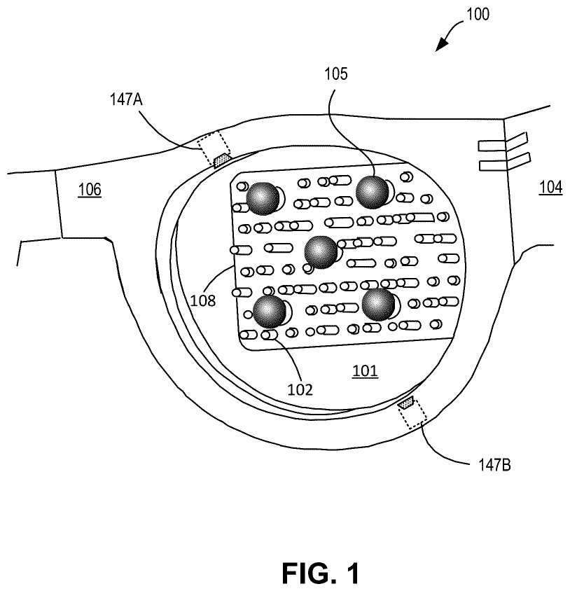

Accordingly, a head mounted device that is removably coupled to a calibration apparatus is described herein. In some aspects, the head mounted device can be calibrated during charging and may be provided as an accessory with the head mounted device. In aspects, an ET camera of the head mounted device can be recalibrated periodically, enabling a similarly high level of performance of the head mounted device to its factory calibration. In aspects, the calibration apparatus includes a plurality of cylinder-shaped 3D objects or pillars having varying heights which are located at varying distances from each other. These and other embodiments are described in more detail in connection with FIGS. 1-5.

FIG. 1 illustrates a portion of a head mounted device 100 coupled to a calibration apparatus 108. Calibration apparatus 108 is removably coupled to a backside of a lens 101 and/or frame 106 of head mounted device 100. In aspects, calibration apparatus 108 includes a plurality of 3D objects including 3D pillars or cylinders 102 as well as 3D spherical surfaces or 3D balls 105 having reflective surfaces. As seen in FIG. 1, 3D pillars or cylinders 102 have varying heights and are located at varying distances from each other. Head mounted device 100 includes a frame 106, a lens 101, and arm 104. In aspects, eye tracking systems may use cameras that are positioned on a frame of the head mounted device. In the example, head mounted device 100 includes ET camera 147A and ET camera 147B. In aspects, ET camera 147A or 147B may take an image of plurality of 3D objects to collect calibration information for each respective ET camera 147A or 147B as well as from the multitude of cameras at the same time to include joint observation of the calibration target. In embodiments, calibration apparatus 108 may be coupled to lens 101 in any suitable manner, mechanical, magnetic, or otherwise, that provides a repeatable stable and secure coupling of calibration apparatus 108 to head mounted device 100.

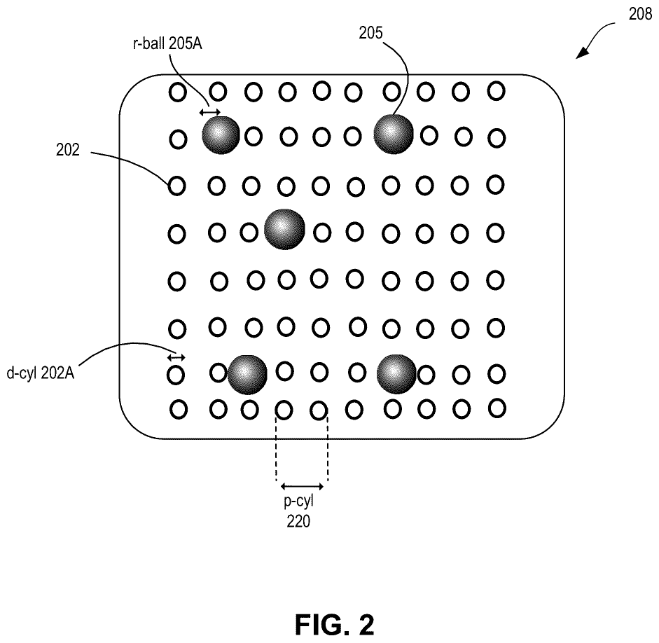

To further illustrate, FIG. 2 is an enlarged planar view of an example calibration apparatus 208, in accordance with aspects of the disclosure. Example calibration apparatus 208 includes a plurality of 3D objects (also “calibration targets”) such as 3D pillars or cylinders 202 and 3D spherical surfaces or 3D balls 205 having mirrored or reflective surfaces. In examples, 3D pillars or cylinders 202 have varying heights. In the present FIG. 2, 3D pillars or cylinders 202 are located at substantially regular distances from each other but typically may be located at varying distances from each other. In various embodiments, the plurality of 3D objects may be arranged in unique patterns to assist in camera recalibration, having different geometrical scales, distances, and 3D objects being extruded or recessed to approximate variations of distances from an eyeball to the 3D objects.

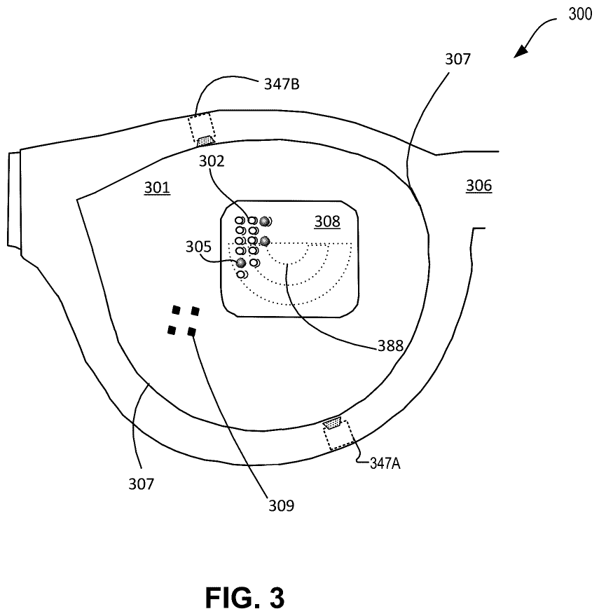

In some examples, a radius of a sphere or some reflective geometries of 3D ball 205 (see r-ball 205A) may be in a range of 8-10 millimeters (mm) and a plane of 3D ball surfaces may be approximately 12 millimeters away from a nominal eye position or frame center (discussed in more detail with respect to FIG. 3). Note that r-ball 205A may be similar to a radius of an eyeball as calibration includes mimicking eye glints in order to achieve accuracy in regards to predicted gaze angle and 3D pupil location.

In some examples, diameters of cylinders (d-cyl 202A) may be in a range of 0.2-1 mm. In various aspects, top surfaces of cylinders 202 may be various distances from a backside plane of frame 206, ranging from 8-12 mm. In some aspects, an average distance between a lens and the calibration apparatus is an eye relief distance of 4.5 mm-20 mm. In the example, distances between two neighboring cylindrical patterns (p-cyl) range from 2-3 mm. In some embodiments, dimension tolerance of these features may be less than 0.05 millimeters and a total number of the 3D objects or calibration targets may vary from 20×20 or 30×20 per eye or lens. Note that these ranges are merely examples and any suitable ranges that can mimic positions of virtual objects to facilitate calibration of an ET camera are contemplated.

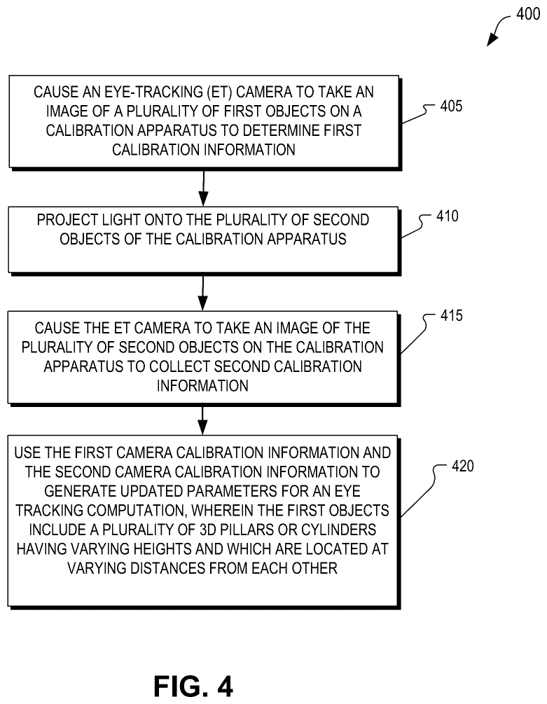

FIG. 3 illustrates another example portion of a head mounted device 300, in accordance with aspects of the disclosure. Head mounted device 300 includes ET cameras 347A and 347B proximate to a periphery of lens 301 mounted to a frame 306. As shown, an array or plurality of near infrared or IR light sources, LED's 309 are located in or on lens 301 and a simplified calibration apparatus is shown at 308. In aspects, a goal of a calibration process is to determine a location of light sources, e.g., LED's 309. In aspects, locations of LED's 309 are determined relative to a projected location 388 of a user's eyeball. To further illustrate, FIG. 4 is an example process 400 described below in conjunction with FIG. 3.

In embodiments, process 400 may be performed by head mounted device 300 or elements of head mounted device 300 discussed further below. At a first process block 405, in some embodiments, an ET camera (e.g., 347A/347B) of FIG. 3) takes an image of first objects, e.g., cylinders 302 on a calibration apparatus 308 to determine first calibration information. In aspects, the first calibration information is used to determine an updated camera model. For example, a calibration of the ET camera lens uses the image to determine an updated location of pillars or cylinders 302 on a 2D pixel plane (e.g., sensor plane). In aspects, the 2D pixel location is mathematically translated to a 3D position, and vice versa (sometimes referred to as intrinsic calibration).

The image of the 3D pillars or cylinders is also used to determine an updated position of the ET camera (sometimes referred to as extrinsic calibration).

In aspects, a position of ET camera 347A or 347B includes an ET camera's position relative to a projected nominal eye position or a frame center. In embodiments, the frame center (e.g., 388) is defined as where an eyeball may sit relative to a frame edge, e.g., 307, when aligned with an optical axis of lens 301.

At a next process block 410, light is projected onto calibration apparatus 308 including the plurality of second objects, 3D balls 305, by LED's 309. In aspects, at next process block 415, the ET camera takes a second image of 3D balls 305 to collect second calibration information including a location of glints on 3D balls 305. In embodiments, the second calibration information can be used to calculate, using geometric optics, a position of one or more of the plurality of light sources, LED's 309.

Thus, at a process block 420, the first and second camera calibration information is used to generate updated parameters for an eye tracking computation. The first camera calibration information includes an image of the plurality of 3D pillars or cylinders. In aspects, the updated camera model information is used together with locations of reflections or glints on 3D balls to determine where LED's 309 are located. Multiple simultaneous images from the cameras along with the different pillars can also be used together to validate the calibrations. In some aspects, the location is a virtual location due to layers in a lens 301 and a location of LEDs 309. In embodiments, process 400 enables new calibration parameters to allow an ET tracking algorithm to compute or re-predict where a user's gaze or pupil is located.

As noted above, processing logic may cause example head mounted device 300 to perform above process 400. In aspects, one or more memories is coupled to the processing logic, the one or more memories storing instructions that when executed by the processing logic, cause head mounted device 300 to perform operations as described above. For simplification, only one lens (a right-eye lens) has been shown. It is understood that a left eye lens of head mounted device 300 may also include another calibration apparatus to calibrate ET cameras associated with the left eye lens.

The order in which some or all of the process blocks appear in process 400 should not be deemed limiting. Rather, one of ordinary skill in the art having the benefit of the present disclosure will understand that some of the process blocks may be executed in a variety of orders not illustrated, or even in parallel.

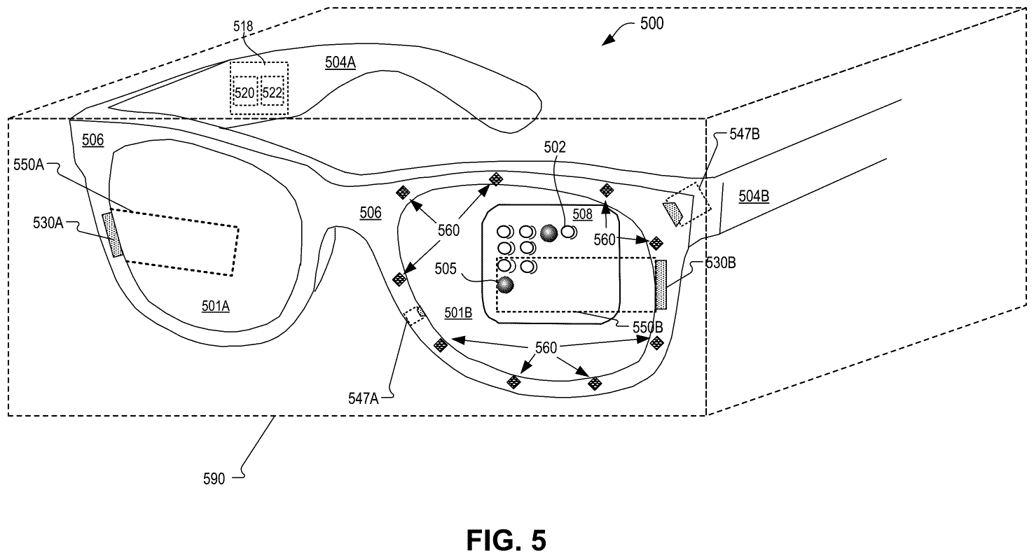

FIG. 5 illustrates another example head mounted device including a calibration apparatus, in accordance with aspects of the disclosure. Head mounted device 500 includes light sources 560 that are located “around the lens” (ATL LEDs), in contrast to “in-field” light sources located in or on a lens 301 of FIG. 3. In the example, head mounted device 500 is removably coupled to calibration apparatus 508 as well as to a charging station 590. In examples, light sources 560 emit light in an eyeward direction to illuminate an eyebox of head mounted device 500 to generate reflections from an eye (or eyes) of a wearer of head mounted device 500.

Light sources 560 may be, for example, light emitting diodes (LEDs), vertical-cavity surface-emitting lasers (VCSELs), micro light emitting diode (micro-LED), an edge emitting LED, a superluminescent diode (SLED), or another type of light source. Light sources 560 emit non-visible light, according to an embodiment. Light sources 560 emit near infrared light, according to an embodiment. Infrared light from other sources may illuminate the eye as well. During operation, reflected light from light sources 560 is reflected off of a user's eye and is received by ET cameras 547A and 547B. In aspects, during calibration, reflected light from light sources 560 create glints on 3D balls 505 that are captured in an image taken by camera 547A and 547B during calibration process 400.

As illustrated, head mounted device 500 includes frame 506 coupled to arms 504A and 504B. Lenses 501A and 501B are mounted to frame 506. Lenses 501A and 501B may appear transparent to a user to facilitate augmented reality or mixed reality to enable a user to view scene light from the environment around her while also receiving image light directed to her eye(s) by, for example, waveguides 550A and 550B. In some aspects, waveguides 550A/550B direct image light generated by a display 530A/530B to an eyebox area for viewing by a user of head mounted device 500. Display 530A/530B may include a liquid crystal display (LCD), an organic light emitting diode (OLED) display, micro-LED display, quantum dot display, pico-projector, or liquid crystal on silicon (LCOS) display for directing image light to a wearer of head mounted device 500.

Note that ET cameras 547A or 547B may include a complementary metal-oxide semiconductor (CMOS) image sensor. Note also that although two ET cameras have been illustrated on the head mounted devices in the FIGS., the number as well as location or position of ET cameras may vary according to features offered by the relevant AR or VR system. Note also that head mounted device 500 may detect a need for calibration and proceed with calibration when not in use or during charging. Charging station 590 may provide a stable platform or cradle for calibration. Charging station 590 may provide wireless or wired power and/or may be configured to be powered by one or more batteries.

In aspects, head mounted device 500 may include supporting hardware incorporated into frame 506 and/or its temple arms (e.g., 504A/504B). The hardware of head mounted device 100 may include, e.g., a controller 518, that may assist in performance of calibration of ET cameras 547A/547B. Controller 518 and/or a processing logic 520 may include circuitry, logic, ASIC circuitry, FPGA circuity, and/or one or more processors. Controller 518 may include any of processing logic 520, wired, and/or wireless data interface for sending and receiving data, graphic processors, and one or more memories 522 for storing data and computer executable instructions. One or more memories 522 may store instructions that when executed by processing logic 520, cause head mounted device 500 to perform operations as described in process 400 of FIG. 4.

Embodiments of the invention may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head mounted device connected to a host computer system, a standalone head mounted device, a mobile device or computing system, or any other hardware platform capable of providing artificial reality content to one or more viewers.

A “memory” or “memories” (e.g. 522) described in this disclosure may include one or more volatile or non-volatile memory architectures. The “memory” or “memories” may be removable and non-removable media implemented in any method or technology for storage of information such as computer-readable instructions, data structures, program modules, or other data. Example memory technologies may include RAM, ROM, EEPROM, flash memory, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device.

A Network that an example head mounted device may be connected to may include any network or network system such as, but not limited to, the following: a peer-to-peer network; a Local Area Network (LAN); a Wide Area Network (WAN); a public network, such as the Internet; a private network; a cellular network; a wireless network; a wired network; a wireless and wired combination network; and a satellite network.

Communication channels may include or be routed through one or more wired or wireless communication utilizing IEEE 802.11 protocols, short-range wireless protocols, SPI (Serial Peripheral Interface), I2C (Inter-Integrated Circuit), USB (Universal Serial Port), CAN (Controller Area Network), cellular data protocols (e.g. 3G, 4G, LTE, 5G), optical communication networks, Internet Service Providers (ISPs), a peer-to-peer network, a Local Area Network (LAN), a Wide Area Network (WAN), a public network (e.g. “the Internet”), a private network, a satellite network, or otherwise.

A computing device may include a desktop computer, a laptop computer, a tablet, a phablet, a smartphone, a feature phone, a server computer, or otherwise. A server computer may be located remotely in a data center or be stored locally.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A system comprising:
a head mounted device including:
an eye tracking (ET) camera;
processing logic coupled to the ET camera; and
a calibration apparatus including a plurality of 3D objects that includes a plurality of 3D pillars or cylinders having varying heights and which are located at varying distances from each other, wherein the calibration apparatus is removably coupled to the head mounted device, wherein the processing logic is to cause the head mounted device to perform operations including to:
cause the ET camera to take an image of the plurality of 3D objects on the calibration apparatus, to collect calibration information; and
use the calibration information to update eye tracking parameters for the ET camera.

2. The system of claim 1 wherein the calibration apparatus further comprises 3D spherical surfaces or 3D balls having reflective surfaces located among the plurality of 3D pillars or cylinders.

3. The system of claim 2, wherein the head mounted device includes light sources, and wherein the processing logic is to further perform operations including to cause the head mounted device to activate the lights sources to project light onto the calibration apparatus.

4. The system of claim 3 wherein the image captures locations of reflections or glints of the light on the 3D spherical surfaces or 3D balls.

5. The system of claim 4 wherein the calibration information includes information to calculate a position of one or more of the light sources.

6. The system of claim 1 wherein the image includes information to determine an updated camera model and updated positions of the ET camera and light sources.

7. The system of claim 1, further comprising a charging station to receive the head mounted device coupled to the calibration apparatus.

8. A method for calibration of a head mounted device, comprising:
causing an eye tracking (ET) camera of the head mounted device to take an image of a plurality of first objects on a calibration apparatus to determine first calibration information;
causing the ET camera to take a second image of a plurality of second objects on the calibration apparatus to collect second calibration information; and
using the first camera calibration information and the second camera calibration information to generate updated parameters for an eye tracking computation, wherein the plurality of first objects include a plurality of 3D pillars or cylinders having varying heights and which are located at varying distances from each other.

9. The method of claim 8 wherein the first calibration information is used to update a camera model of the ET camera which maps a 2D pixel plane location to a 3D object location.

10. The method of claim 9 wherein the varying heights of the plurality of 3D pillars or cylinders are to approximate variations of distances from an eyeball to 3D locations.

11. The method of claim 9 wherein the first calibration information is to update a position of the ET camera relative to a projected location of an eye of a user.

12. The method of claim 8, further comprising prior to causing the ET camera to take the second image, projecting light onto the plurality of second objects of the calibration apparatus using a plurality of light sources of the head mounted device.

13. The method of claim 12 wherein the second objects include mirrored 3D spherical surfaces or mirrored 3D balls and wherein the second calibration information is used to calculate a position of one or more of the plurality of light sources.

14. The method of claim 8 wherein the updated parameters are generated at similar times as when charging of the head mounted device occurs.

15. The method of claim 8 wherein the calibration apparatus is removably coupled to a backside of the lens of the head mounted device.

16. A non-transitory machine-accessible storage medium that provides instructions that, when executed by a machine, will cause the machine to perform operations comprising to:
cause an eye tracking (ET) camera to take an image of a plurality of 3D objects on a calibration apparatus, to collect calibration information; and
use the calibration information to update eye tracking parameters for the ET camera, wherein the plurality of 3D objects includes 3D pillars or cylinders that have varying heights and which are located at varying distances from each other to mimic 3D object locations relative to the ET camera.

17. The non-transitory machine-accessible storage medium of claim 16, wherein the to update eye tracking parameters includes to use the image to update a correlation between a position of 3D objects to a 2D pixel plane as seen by an eye and to update a position of the ET camera.

18. The non-transitory machine-accessible storage medium of claim 16, further providing instructions that, when executed by the machine, will cause the machine to perform further operations, comprising to:
project light onto the calibration apparatus to create glints or reflections on an additional plurality of 3D objects; and
cause the ET camera to take an additional image to capture the glints or reflections on the additional plurality of 3D objects.

19. The non-transitory machine-accessible storage medium of claim 18 wherein the additional plurality of 3D objects mimic an eyeball.

20. The non-transitory machine-accessible storage medium of claim 18, further providing instructions that, when executed by the machine, will cause the machine to perform further operations, comprising to compute a location of LEDs based at least in part upon a location of the glints or reflections on the additional plurality of 3D objects.
